(19) United States
(12) Patent Application Publication
(10) Pub. No.: US 2018/0314833 A1
(43) Pub. Date: Nov. 1, 2018

(54) RISK ANALYSIS TO IDENTIFY AND RETROSPECT CYBER SECURITY THREATS

(71) Applicant: Honeywell International Inc., Morris Plains, NJ (US)

(72) Inventors: Chandrakanth Vittal, Bangalore (IN); Swetha Subramanian, Chennai (IN); Venkata Srinivasulu Reddy Talamanchi, Bangalore (IN); Seth G. Carpenter, Phoenix, AZ (US); Prasad Kamath, Bangalore (IN)

(21) Appl. No.: 15/581,352

(22) Filed: Apr. 28, 2017

(51) Int. Cl. G06F 21/57; H04L 29/06; G06Q 10/06

(52) U.S. Cl. CPC G06F 21/577; H04L 63/1433; G06F 2221/034; H04L 63/1408; G06Q 10/0635

(57) ABSTRACT

This disclosure provides an apparatus and method for identifying and retrospecting cyber security threats, including but not limited to in industrial control systems and other systems. A method includes receiving, by a risk manager system, a selection of an asset for analysis. The method includes receiving, by the risk manager system, current and historical cyber-risk data corresponding to the asset. The method includes receiving a user selection of one or more data options for analysis of the asset. The method includes identifying relevant portions of the current and historical cyber-risk data according to the selected data options. The method includes producing an output corresponding to the selected asset, the selected data options, and the identified relevant portions of the current and historical cyber-risk data. The method includes displaying the output as a report in a graphical user interface.

### TECHNICAL FIELD

This disclosure relates generally to network security. More specifically, this disclosure relates to an apparatus and method for risk analysis to identify and retrospect cyber security threats.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility.

### SUMMARY

This disclosure provides an apparatus and method for identifying and retrospecting cyber security threats. A method includes receiving, by a risk manager system, a selection of an asset for analysis. The method includes receiving, by the risk manager system, current and historical cyber-risk data corresponding to the asset. The method includes receiving a user selection of one or more data options for analysis of the asset. The method includes identifying relevant portions of the current and historical cyber-risk data according to the selected data options. The method includes producing an output corresponding to the selected asset, the selected data options, and the identified relevant portions of the current and historical cyber-risk data. The method includes displaying the output as a report in a graphical user interface.

Disclosed embodiments include a risk manager system comprising a controller and a memory, configured to perform processes as described herein. Disclosed embodiments also include a non-transitory machine-readable medium encoded with executable instructions that, when executed, cause one or more processors of a risk manager system to perform processes as disclosed herein.

In various embodiments, the asset is one of a plurality of connected devices that are vulnerable to cyber-security risks. In various embodiments, a selected asset is rejected if the asset is not the first asset in a group and is not the same asset type as other assets in the group. In various embodiments, identifying relevant portions of the current and historical cyber-risk data according to the selected data options is performed by an analysis engine. In various embodiments, the current and historical cyber-risk data corresponding to the asset is received in a container from an analysis container. In various embodiments, the risk manager system also displays the data options to a user. In various embodiments, the selected one or more data options include at least one of data options displayed to a user, a date range, or a type of view.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a high-level architecture diagram in accordance with disclosed embodiments;

FIG. 3 illustrates a process in accordance with disclosed embodiments as can be performed by a risk manager system; and

FIGS. 4 and 5 illustrate examples of graphical user interfaces in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

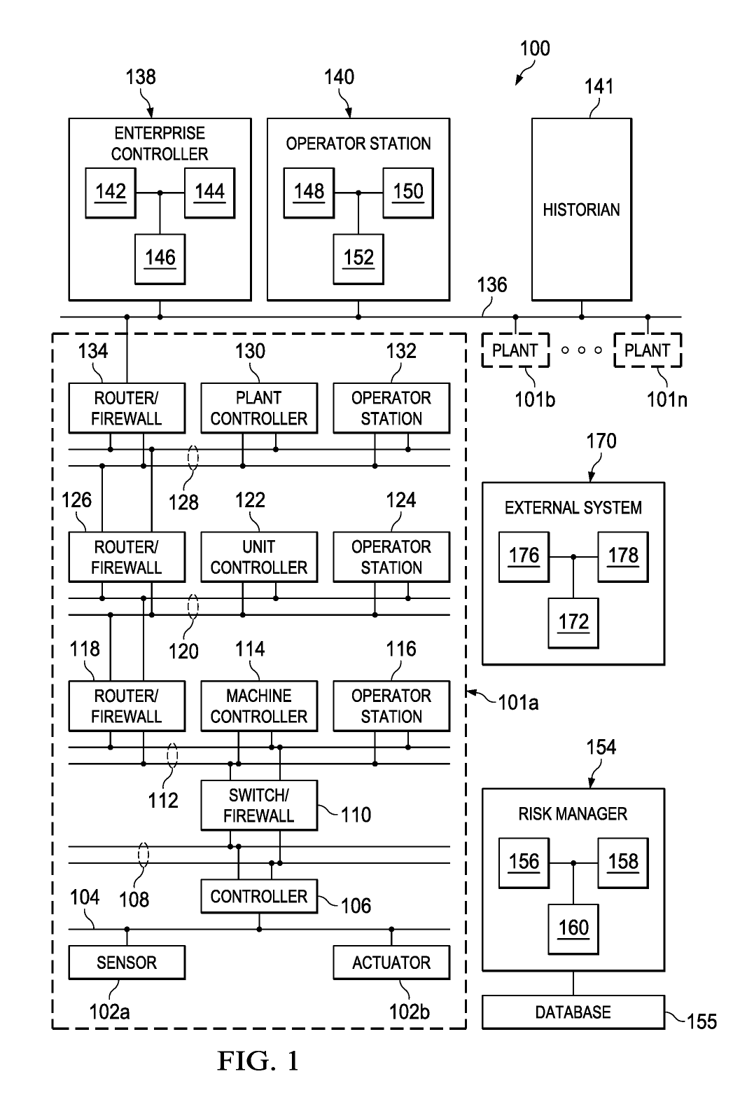

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n, Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multi variable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, cyber-security is of increasing concern with respect to industrial process control and automation systems. Today's industrial plants are victims of frequent cyber-attacks and there is a need for proactively identifying threats to the critical infrastructure. It is a practice and a mandate to have cyber security administrators who can proactively administer the happenings on an industrial control network which contains a mix of WINDOWS servers and workstations, switches, routers, firewalls, safety systems, proprietary real-time controllers and field devices, all of which are included as examples of devices in system 100. These assets are critical infrastructure of an industrial plant.

When an abnormal activity is suspected on an industrial plant network, the cyber security or plant network administrator will want to retrospect and perform in depth analysis of the abnormal activity during the suspected period. Disclosed embodiments include systems and methods to support this retrospection.

Some of the typical scenarios include but are not limited to comparing data of multiple cyber assets in different time lines to review the changes and to quickly understand the changes during the time period. As another example, when a cyber-risk is suspected on a cyber-asset, gathering data to drill deep into as much level of data as possible associated with the asset to discover the root of the problem and help determine the subsequent remediation to it. As another example, when there are changes to the cyber asset in terms of hardware or software updates, reviewing the change timelines.

These activities require manual effort to gather and collate different logs/data from each of the cyber asset and also requires analytical and network knowledge to perform data massaging.

Disclosed embodiments provide an analysis solution that can dynamically bring heterogeneous data into a single platform to perform effective cyber risk analysis,

This can be accomplished (among other ways) using a risk manager 154. Among other things, the risk manager 154 supports a technique for identifying and retrospecting cyber security threats.

In this example, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions. In some embodiments, the risk manager 154 includes, or is in communication with, a database 155. The database 155 denotes any suitable structure facilitating storage and retrieval of information.

Disclosed embodiments enable the efficient analysis and reporting of risk manager data from a system such as the risk manager 154. The analysis and reporting can also or alternatively be accessed or performed, in some cases, by an external system 170. In this example, the external system 170 includes one or more processing devices 176; one or more memories 178 for storing instructions and data used, generated, or collected by the processing device(s) 176; and at least one network interface 172. Each processing device 176 could represent a microprocessor, microcontroller, digital signal process, field programmable gate array, application specific integrated circuit, or discrete logic. Each memory 178 could represent a volatile or non-volatile storage and retrieval device, such as a random access memory or Flash memory. Each network interface 172 could represent an Ethernet interface, wireless transceiver, or other device facilitating external communication. The functionality of the external system 170 could be implemented using any suitable hardware or a combination of hardware and software/firmware instructions. The external system 170 can be, for example, a stand-alone data processing system, a mobile device, an external server or enterprise system, or otherwise. The exemplary structure of the external system 170 described above is not intended to limit the structure or function of the devices that could be used to implement the external system 170.

Although FIG. 1 illustrates one example of an industrial process control and automation system IOU, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

In some risk manager implementations, the user installing and configuring the risk manager would be responsible for verifying that each end device is ready for monitoring. In many cases, a user will simply attempt to monitor the end device and hope there are no adverse effects. The attempt to monitor the device may also fail, leaving the user to contact technical support or try independently troubleshooting.

Disclosed embodiments provide a visualization component where the heterogeneous cyber assets are listed and the users will be able to build scenario based visuals that can aid them to analyze the data and troubleshoot cyber risks. After building the contextual scenarios, users can playback the events and intercept abnormal activities. The “assets” can include servers and workstations, switches, routers, firewalls, safety systems, proprietary real-time controllers and field devices, zones identifying multiple devices, and any other devices in the system 100.

In various embodiments, the risk manager 154 can display an asset hierarchy which has custom procedures to identify the cyber assets that have been added and removed from the system 100. The entry and exit of devices is recorded in a storage such as database 155. This visualization identifies the multiple entries and exits of each asset and displays them under all the hierarchy where it belonged to during its lifecycle.

In various embodiments, the assets can be added to the analysis through a simplified drag and drop feature. The drag feature which carries the cyber asset identifies critical data of the asset that is required for the analysis. For example, if a cyber asset such as a zone is dragged and dropped, the system automatically identifies data options like risk score, risk area, active risk indicators, etc., for that zone.

In various embodiments, the asset data can be viewed as a visual in various forms such as tabular, trend, or matrix. This provides the novel ability to change to any visual type for the same data to enable efficient comparison of data and proactively unearth improper configuration and implicit risks. The type of the visual available for the data of the asset can also be dynamically determined.

In various embodiments, current and historic Key Performance Indicators (KPIs) provide metrics on how cyber risks are being managed.

In various embodiments, the generated analysis can be saved, exported and shared to different users. The generated analysis can also be saved as a template and can be reused later to build on demand reports and scheduled reports. The rendered analysis view is not stored in the database, but rather the position and contents of the various components (like the dropped items, type of view, type of data options, start date, end date). This way, when a saved view is loaded, the latest data can be retrieved.

In various embodiments, the saved analysis at the site level can be securely viewed at the enterprise level and the above features can be extended for risk analysis at the enterprise level as well. The secured transfer of data across levels can be accomplished by enforcing encryption on the TCP channel.

In some cases, the dashboard can have all the cyber assets listed in their logical group hierarchy which can be dragged and dropped to analyze its associated data in multiple views. A cyber asset can be a site, zone, device, risk area or a risk indicator. Each asset will have a number of properties that can be used for analysis of the abnormal activity to identify cyber risks.

Various embodiments include multiple system-built reports available for each site which has data analysis of sites, zones, threats, vulnerabilities, backup risks, patch risks, and the current inventory.

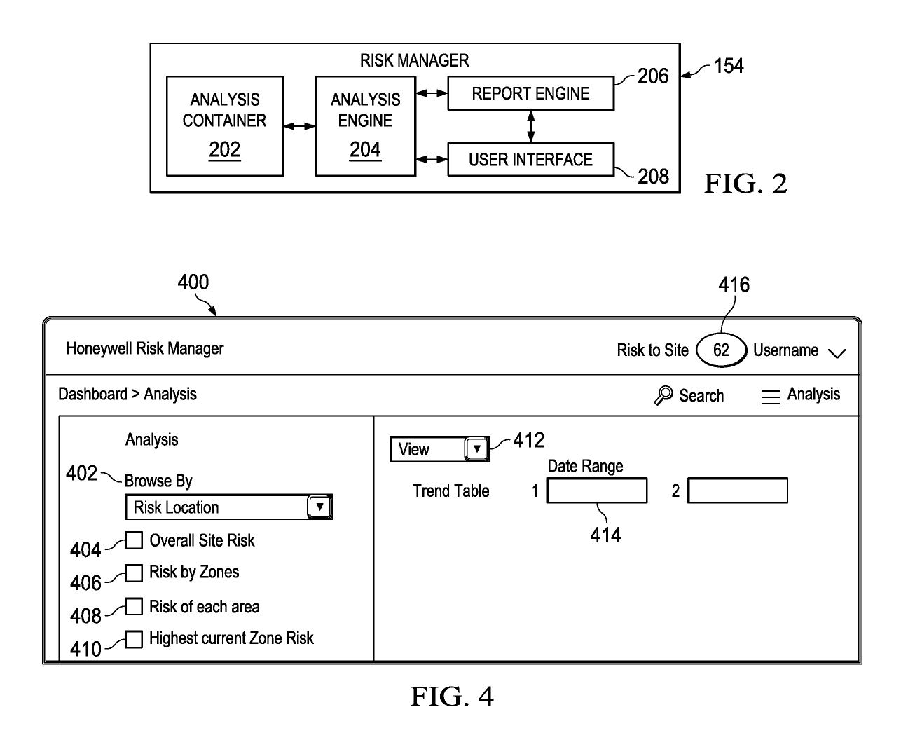

FIG. 2 illustrates a high level architecture diagram in a accordance with disclosed embodiments, that can be implemented in a risk manager 154.

An analysis container 202 represents a view of related data for an asset or group of assets. The analysis container can include any data such as asset information used by an analysis engine 204 for further processing, and the analysis container 202 can manage a plurality of other data containers storing data corresponding to various assets, including current and historical cyber-risk data. In some cases, the analysis container 202 can dynamically create data containers for sending data to other devices or processes. For example, one analysis container 202 might show a trend of the calculated risk scores for all devices in a single zone over a period of 30 days. This analysis container 202 could be represented in the analysis view of user interface 208 as a trend with a legend showing each value for each asset over that period. A single analysis view can have one to many analysis containers 202. Mismatched data types are typically not shown in the same container; e.g., a trended risk score would not be shown with a KPI for current site risk, or a trend of a device would not be shown mixed into a trend of distributed sites. The view can include data corresponding to analysis container 202 or any data container managed or sent by analysis container 202.

The analysis engine 204 processes any asset under investigation with the current and the historized risk manager data to get the relevant data for generating analysis. For example, if an analysis container 202 contains five devices and is evaluating the risk score of each device, the analysis engine 204 can query the “risk score” parameter for each device within the currently selected time range. The resulting data set would then be passed to the report engine 206 or the user interface 208 for display, and can be sent in a data container.

The report engine 206 further processes the data returned from the analysis engine 204 and displays the final analysis into the user interface 208. The particular display of data will depend on the current settings the user has selected. For example, historic trends might be displayed as a single large chart with all lines present or as a stacked series of smaller individual trends.

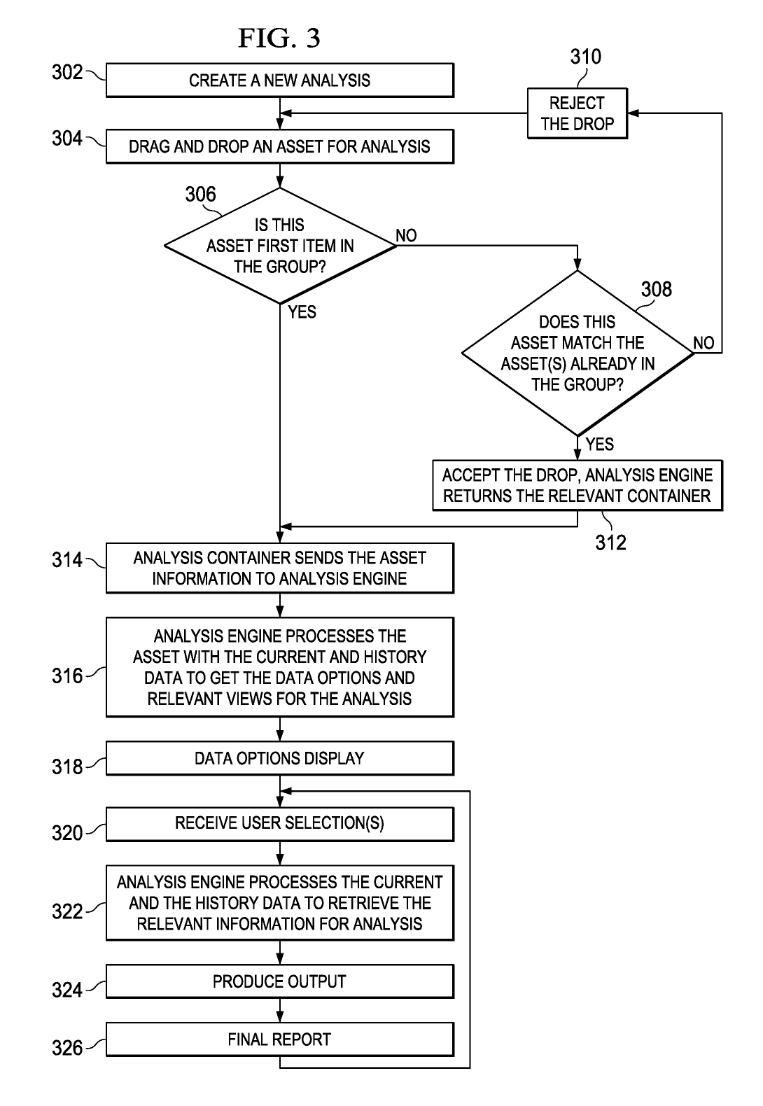

FIG. 3 illustrates a process in accordance with disclosed embodiments as can be performed by a risk manager system 154 (the “system” below).

The system receives an instruction to create a new analysis (302).

The system receives a selection of an asset for analysis (304). This can be, for example, by receiving a “drag and drop” of an icon or other element representing the asset into a designated portion of the risk manager graphic user interface. The asset can be one of a plurality of connected devices that are vulnerable to cyber-security risks.

The system determines if the selected asset is the first item in a group (306). The “first item” refers to the first item to be added to the group, so that it is the sole item in the group at that point.

If it is not the first item in the group (No), the system determines if the new asset matches the asset(s) already in the group (308). “Matching” can include being of the same type, category, zone, or otherwise.

If the new item does not match the assets already in the group (No), then the system rejects the addition of the selected asset (310). If the new item does not match the assets already in the group (Yes), then the system accepts the addition of the selected asset (312) and the analysis container returns the data container corresponding to the asset to the analysis engine.

If the selected asset is the first item in the group at 306 (Yes), the analysis container returns the data container corresponding to the asset to the analysis engine (314). More generically, the system receives a data container containing current and historical cyber-risk data corresponding to the asset.

The system, using the analysis engine, processes the asset with current and historical cyber-risk data to produce data options and relevant views for the analysis (316).

The system displays, in the user interface, data options for analysis of the asset (318).

The system receives a user selection of one or more data options for analysis of the asset (320). These can include one of the displayed data options, a date range, a type of view, or other options.

The system, using the analysis engine, identifies relevant portions of the current and historical cyber-risk data according to the selected data options (322).

The system, using the report engine, produces an output corresponding to the asset(s) in the group, the selected data options, and the identified relevant portions of the current and historical cyber-risk data (324). By using both current and historical cyber-risk data, the system identifies and retrospects cyber security threats.

The system displays the output as a report in the graphical user interface (326). The system can also store the report in the database. The system can return to 320 to receive other or additional user selections.

The creation and operation of the analysis view can include an analysis by a rules engine for example as described in the applications incorporated below. The rules engine processes raw data at the site and turns it into actionable risk items. That data is transformed and stored in the database 155 for retrieval by other subsystems such the analysis engine 204. Such a rules engine can also generate the KPIs described herein.

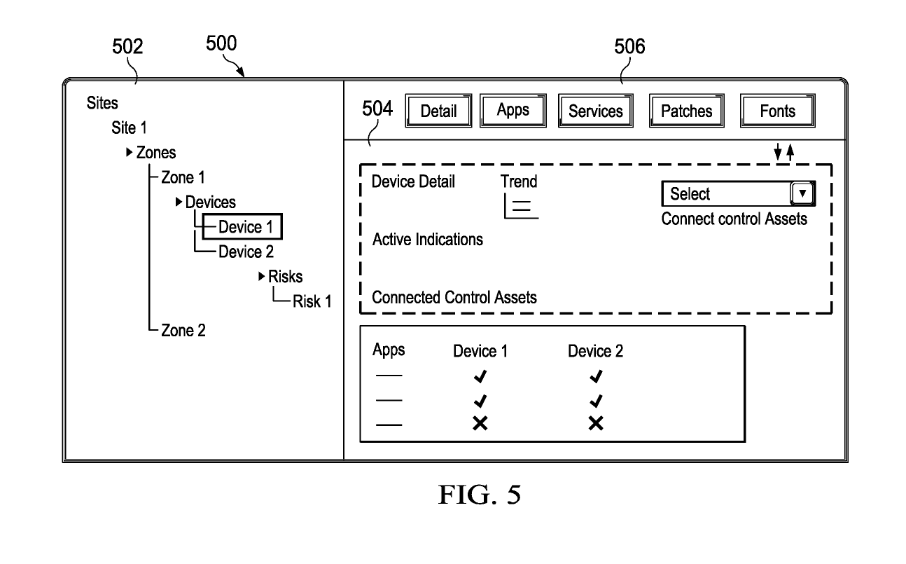

FIG. 4 illustrates an example of a graphical user interface (GUI) in accordance with disclosed embodiments.

The GUI 400 illustrates data options as can be displayed by the system. These can include a “browse by” selection 402, such as browsing by risk location, zone, asset type, or others.

Data options can include overall site risk 404, risk by zones 406, risk at each area 408, or highest current zone risk 410.

Data options can include a view selection 412, such as trend, tabular, matrix, or other. Data options can include a date range 414. The GUI 400 can also show a risk to site value 416.

FIG. 5 illustrates an example of a GUI in accordance with disclosed embodiments.

The GUI 500 illustrates some elements of a user interface 208 that can be displayed by the system as part of a dashboard. This can include a logical group hierarchy 502 that shows assets arranged, in this example, by sites, zones, devices, and risks. It can include a device detail 504 including such information as trend data or graphs, active indicators, and control assets. It can include data selectors 506 for such elements as device detail, apps, services, patches, fonts, and others.

Note that the risk manager 154 and/or the other processes, devices, and techniques described herein could use or operate in conjunction with any combination or all of various features described in the following previously-filed patent applications (all of which are hereby incorporated by reference):

U.S. patent application Ser. No. 14/482,888 entitled “DYNAMIC QUANTIFICATION OF CYBER-SECURITY RISKS IN A CONTROL SYSTEM”;

U.S. Provisional Patent Application No. 62/036,920 entitled “ANALYZING CYBER-SECURITY RISKS IN AN INDUSTRIAL CONTROL ENVIRONMENT”;

U.S. Provisional Patent Application No. 62/113,075 entitled “RULES ENGINE FOR CONVERTING SYSTEM-RELATED CHARACTERISTICS AND EVENTS INTO CYBER-SECURITY RISK ASSESSMENT VALUES” and corresponding non-provisional U.S. patent application Ser. No. 14/871,695;

U.S. Provisional Patent Application No. 62/113,221 entitled “NOTIFICATION SUBSYSTEM FOR GENERATING CONSOLIDATED, FILTERED, AND RELEVANT SECURITY RISK-BASED NOTIFICATIONS” and corresponding non-provisional U.S. patent application Ser. No. 14/871,521;

U.S. Provisional Patent Application No. 62/113,100 entitled “TECHNIQUE FOR USING INFRASTRUCTURE MONITORING SOFTWARE TO COLLECT CYBER-SECURITY RISK DATA” and corresponding non-provisional U.S. patent application Ser. No. 14/871,855;

U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. 14/871,732;

U.S. Provisional Patent Application No. 62/113,165 entitled “PATCH MONITORING AND ANALYSIS” and corresponding non-provisional U.S. patent application Ser. No. 14/871,921;

U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. 14/871,503;

U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. 14/871,605;

U.S. Provisional Patent Application No. 62/114,865 entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS” and corresponding non-provisional U.S. patent application Ser. No. 14,871,814; and

U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. 14/871,136; and

U.S. Provisional Patent Application No. 62/116,245 entitled “RISK MANAGEMENT IN AN AIR-GAPPED ENVIRONMENT” and corresponding non-provisional U.S. patent application Ser. No. 14/871,547.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C. A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, by a risk manager system, a selection of an asset for analysis;
receiving, by the risk manager system, current and historical cyber-risk data corresponding to the asset;
receiving a user selection of one or more data options for analysis of the asset;
identifying relevant portions of the current and historical cyber-risk data according to the selected data options;
producing an output corresponding to the selected asset, the selected data options, and the identified relevant portions of the current and historical cyber-risk data; and
displaying the output as a report in a graphical user interface.

2. The method of claim 1, wherein the asset is one of a plurality of connected devices that are vulnerable to cyber-security risks.

3. The method of claim 1, wherein the selected asset is rejected if the asset is not the first asset in a group and is not the same asset type as other assets in the group.

4. The method of claim 1, wherein identifying relevant portions of the current and historical cyber-risk data according to the selected data options is performed by an analysis engine.

5. The method of claim 1, wherein the current and historical cyber-risk data corresponding to the asset is received in a data container from an analysis container.

6. The method of claim 1, further comprising:
displaying, by the risk manager system, the data options to a user.

7. The method of claim 1, wherein the selected one or more data options include at least one of data options displayed to a user, a date range, or a type of view.

8. A risk manager system comprising:
a controller; and
a memory, the controller configured to:
receive a selection of an asset for analysis;
receive current and historical cyber-risk data corresponding to the asset;
receive a user selection of one or more data options for analysis of the asset;
identify relevant portions of the current and historical cyber-risk data according to the selected data options;
produce an output corresponding to the selected asset, the selected data options, and the identified relevant portions of the current and historical cyber-risk data; and
display the output as a report in a graphical user interface.

9. The risk manager system of claim 8, wherein the asset is one of a plurality of connected devices that are vulnerable to cyber-security risks.

10. The risk manager system of claim 8, wherein the selected asset is rejected if the asset is not the first asset in a group and is not the same asset type as other assets in the group.

11. The risk manager system of claim 8, wherein identifying relevant portions of the current and historical cyber-risk data according to the selected data options is performed by an analysis engine.

12. The risk manager system of claim 8, wherein the current and historical cyber-risk data corresponding to the asset is received in a data container from an analysis container.

13. The risk manager system of claim 8, wherein the controller is further configured to display the data options to a user.

14. The risk manager system of claim 8, wherein the selected one or more data options include at least one of data options displayed to a user, a date range, or a type of view.

15. A non-transitory machine-readable medium encoded with executable instructions that, when executed, cause one or more controllers of a risk manager system to:
receive a selection of an asset for analysis;
receive current and historical cyber-risk data corresponding to the asset;
receive a user selection of one or more data options for analysis of the asset;
identify relevant portions of the current and historical cyber-risk data according to the selected data options;
produce an output corresponding to the selected asset, the selected data options, and the identified relevant portions of the current and historical cyber-risk data; and
display the output as a report in a graphical user interface.

16. The non-transitory machine-readable medium of claim 15, wherein the asset is one of a plurality of connected devices that are vulnerable to cyber-security risks.

17. The non-transitory machine-readable medium of claim 15, wherein the selected asset is rejected if the asset is not the first asset in a group and is not the same asset type as other assets in the group.

18. The non-transitory machine-readable medium of claim 17, wherein identifying relevant portions of the current and historical cyber-risk data according to the selected data options is performed by an analysis engine.

19. The non-transitory machine-readable medium of claim 15, wherein the current and historical cyber-risk data corresponding to the asset is received in a data container from an analysis container.

20. The non-transitory machine-readable medium of claim 15, wherein the selected one or more data options include at least one of data options displayed to a user, a date range, or a type of view.
